(19) United States
(12) Patent Application Publication
(10) Pub. No.: US 2019/0329811 A1
(43) Pub. Date: Oct. 31, 2019

(54) SKID FOR ASSISTING MOBILITY OF PORTABLE COOLERS

(71) Applicants: Royce Preston Jones, Canton, IL (US); Kurt Thomas Messenger, Bolingbrook, IL (US)

(72) Inventors: Royce Preston Jones, Canton, IL (US); Kurt Thomas Messenger, Bolingbrook, IL (US)

(21) Appl. No.: 16/113,237

(22) Filed: Aug. 27, 2018

Related U.S. Application Data
(60) Provisional application No. 62/662,360, filed on Apr. 25, 2018.

(51) Int. Cl. B62B 19/02; B62B 5/00; B62B 1/16

(52) U.S. Cl. CPC B62B 19/02; B62B 5/00; B62B 1/16; F25D 3/06; B62B 2501/06; B62B 2202/90; B62B 2501/00; B62B 2501/065

(57) ABSTRACT

A skid including an upper surface having a concave shape running from a leading edge to a trailing edge and a lower surface having a convex shape running from the leading edge to the trailing edge. A storage compartment having a pair of wheels and an upstanding handle rolls onto the upper surface of the skid. The skid aids in transporting the storage compartment across sand or snow.

### CROSS-REFERENCE TO RELATED APPLICATION

This application claims the benefit of priority of U.S. provisional application No. 62/662,360, filed Apr. 25, 2018, the contents of which are herein incorporated by reference.

### BACKGROUND OF THE INVENTION

The present invention relates to transporting coolers and, more particularly, to a skid for assisting mobility of portable coolers over sand and snow.

Portable coolers with the handle and wheels located on the same side can be exceptionally difficult to drag through sand or snow, as the wheels can become clogged and the body of most coolers cannot compensate for this, causing the cooler to be slowed and increasing the required effort from the user to pull the cooler along.

As can be seen, there is a need for a skid for assisting mobility of portable coolers over sand and snow.

### SUMMARY OF THE INVENTION

In one aspect of the present invention, a method of transporting a cooler comprises steps of: providing a skid comprising: an upper surface comprising concave shape running from a leading edge to a trailing edge; and a lower surface comprising a convex shape running from the leading edge to the trailing edge; providing a storage compartment comprising at least a pair of wheels and an upstanding handle; rolling the pair of wheels over the leading edge of the skid and onto the upper surface; and pulling the storage compartment, wherein the skid stays on the wheels while the storage compartment is being pulled.

In another aspect of the present invention, a skid comprises: an upper surface comprising a concave shape running from a leading edge to a trailing edge; a lower surface comprising a convex shape running from the leading edge to the trailing edge; a first upstanding wall extending upward form a first side of the upper surface and a second upstanding wall extending upward from a second side of the upper surface; a flat plate extending from the leading edge; and a notch formed on the trailing edge.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a rear perspective view of an embodiment of the present invention;

FIG. 3 is a front perspective view of an embodiment of the present invention shown in use;

FIG. 4 is a side, section view of an embodiment of the present invention shown in use;

FIG. 5 is a rear perspective view of an embodiment of the present invention shown in use; and

FIG. 6 is a front exploded view of an embodiment of the present invention illustrating a counterbalance weight.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a skid for assisting portable coolers with travel over sand or snow. The skid of the present invention allows for coolers with a large internal volume and small wheels to cooperate with the user as it is dragged over sand or snow by acting as a friction reducing surface, while also utilizing a relatively small form factor to prevent taking up excess transportation space.

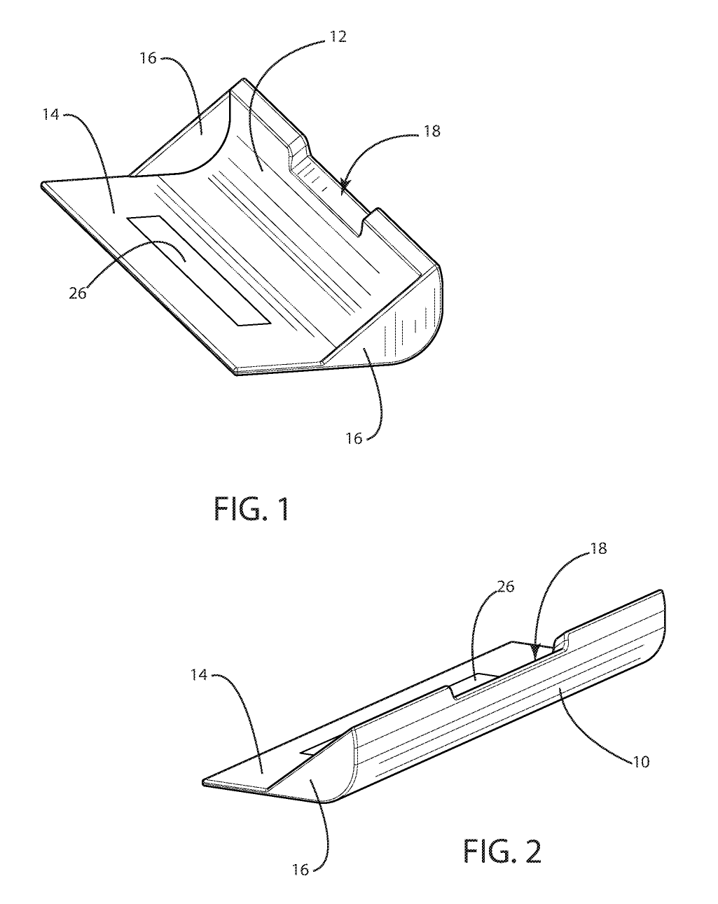

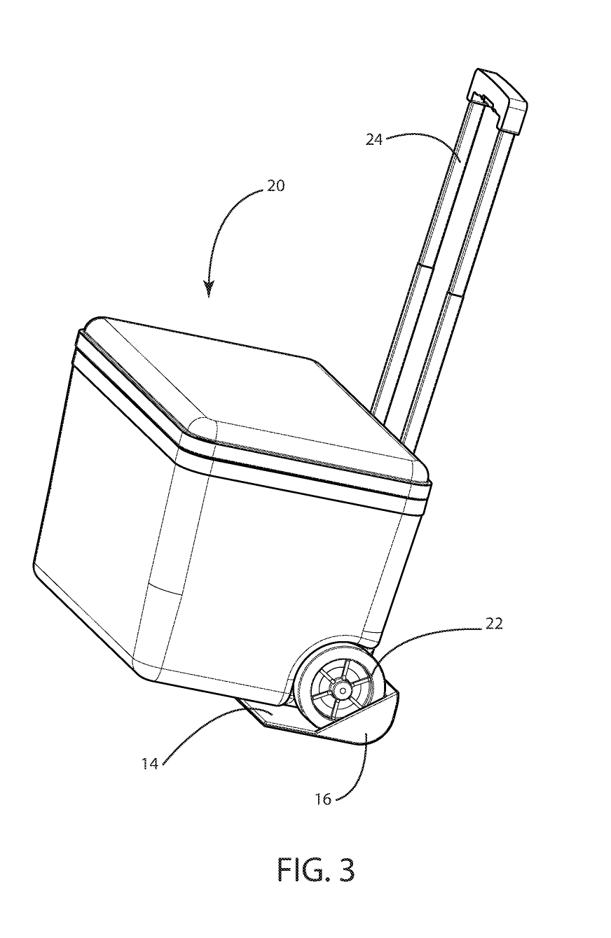

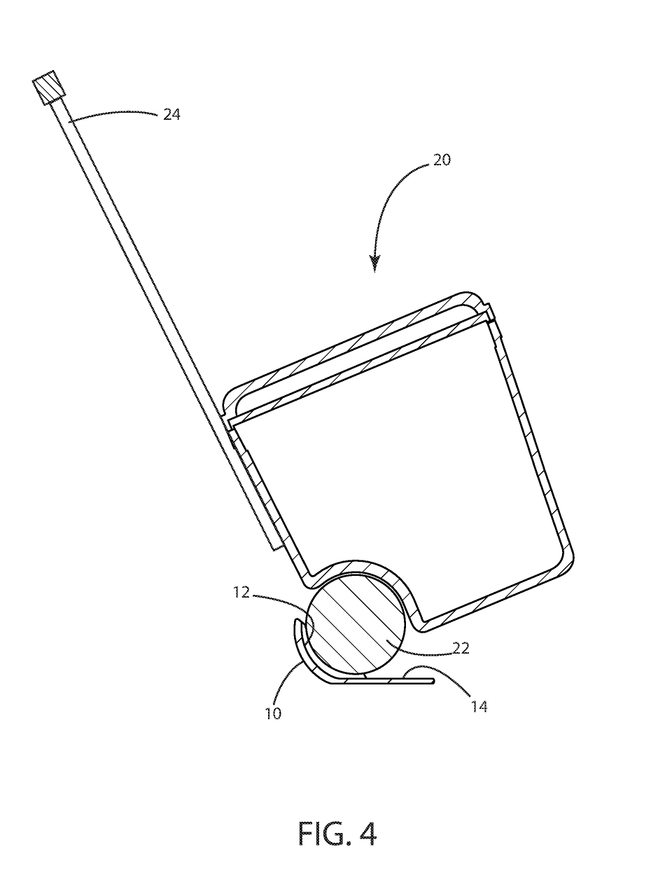

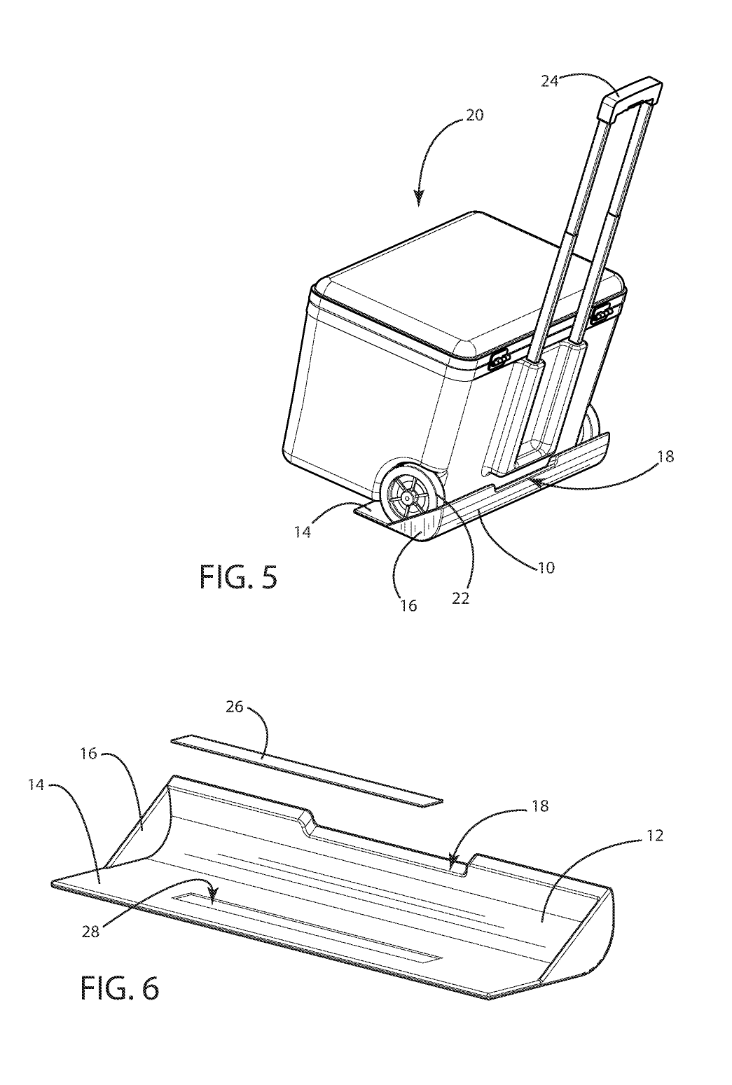

Referring to FIGS. 1 through 6, the present invention includes a skid. The skid includes an upper surface 12 having a concave shape running from a leading edge to a trailing edge. The skid further includes a lower surface 10 having a convex shape running from the leading edge to the trailing edge. A storage compartment 20 having a pair of wheels 22 and an upstanding handle 24 rolls onto the upper surface 12 of the skid when transporting the storage compartment 22 across sand or snow.

In certain embodiments, the storage compartment 20 is a cooler made of insulating material. The cooler may include a housing having a front, a rear, a first side, a second side, a top, and a bottom. A lid may hinged at the top of the housing. The extendable handle 24 and a pair of wheels 22 may be coupled to the housing at the front the cooler.

In certain embodiments, the skid may further include a first upstanding wall 16 extending upward form a first side of the upper surface 12 and a second upstanding wall 16 extending upward from a second side of the upper surface 12. The first upstanding wall 16 and the second upstanding wall 16 may protect the wheels 22 when the storage compartment 20 is being dragged across snow or sand.

The skid of the present invention may further include a flat plate 14 extending from the leading edge. The flat plate 14 may support the skid on a surface so that the upper surface is extending vertically. The pair of wheels 22 may roll onto the flat plate 14 and fit within the concave upper surface 12. The skid then rocks such that the lower surface 10 is engaging the ground and the flat plate 14 is pivoted upward when the storage compartment 20 is being dragged across snow or sand.

In certain embodiments, the skid may further include a notch 18 formed on the trailing edge. The notch 18 may be rectangular in shape and may receive a portion of the handle 24 when the skid rocked over and in use.

A method of using the present invention may include the following. The user places the skid on the ground (in sand or snow) and then places their foot in front of the skid to prevent it from moving forward. The user pulls their portable cooler onto the skid over the flat plate 14 until the pair of wheels 22 fit within the concave upper surface 12. The user may then remove their foot from in front of the skid and drag their portable cooler normally. The skid reduces the drag felt on the cooler by the user.

The main body of the skid can be cast from aluminum or injection molded from plastic. The present invention may further include a counterbalance 26 weight made of steel for the aluminum body or made from aluminum for the plastic body. The counterbalance 26 may sit within a cavity 28 at the rear of the skid. The counterbalance 26 may keep the skid level and allows the skid to glide over sand or snow without tipping over.

It should be understood, of course, that the foregoing relates to exemplary embodiments of the invention and that modifications may be made without departing from the spirit and scope of the invention as set forth in the following claims.

What is claimed is:

1. A method of transporting a cooler comprising steps of:
providing a skid comprising:
an upper surface comprising concave shape running from a leading edge to a trailing edge; and
a lower surface comprising a convex shape running from the leading edge to the trailing edge;
providing a storage compartment comprising at least a pair of wheels and an upstanding handle;
rolling the pair of wheels over the leading edge of the skid and onto the upper surface; and
pulling the storage compartment, wherein the skid stays on the wheels while the storage compartment is being pulled.

2. The method of claim 1, wherein the storage compartment is a cooler made of insulating material.

3. The method of claim 1, wherein the skid further comprises a first upstanding wall extending upward form a first side of the upper surface and a second upstanding wall extending upward from a second side of the upper surface.

4. The method of claim 1, wherein the skid further comprises a flat plate extending from the leading edge.

5. The method of claim 1, wherein the skid further comprises a notch formed on the trailing edge, wherein a portion of the handle is disposed within the notch.

6. A skid comprising:
an upper surface comprising a concave shape running from a leading edge to a trailing edge;
a lower surface comprising a convex shape running from the leading edge to the trailing edge;
a first upstanding wall extending upward form a first side of the upper surface and a second upstanding wall extending upward from a second side of the upper surface;
a flat plate extending from the leading edge; and
a notch formed on the trailing edge.
